(19) United States
(12) Patent Application Publication
(10) Pub. No.: US 2017/0169007 A1
(43) Pub. Date: Jun. 15, 2017

(54) Graphical User Interface for Generating Structured Search Queries

(71) Applicant: Quixey, Inc., Mountain View, CA (US)

(72) Inventor: Thomas FRANCIS, Dubuque, IA (US)

(21) Appl. No.: 14/970,487

(22) Filed: Dec. 15, 2015

(51) Int. Cl. G06F 17/27; G06F 17/30; G06F 3/0482; G06F 17/24; G06F 3/0484

(52) U.S. Cl. CPC G06F 17/278; G06F 17/24; G06F 3/04842; G06F 3/0482; G06F 17/30657; G06F 17/30477

(57) ABSTRACT

According to some implementations of the disclosure, a method is presented. The method includes displaying a graphical user interface including a search bar, receiving initial text input at the search bar, and determining whether at least a portion of the initial text input matches a recognized pattern. When the text input matches one or more recognized patterns, the method includes: presenting one or more input clarification elements corresponding to the one or more matching recognized patterns; receiving a selection of one of the input clarification elements; receiving an execution command at the search bar; generating a structured search query based on the selected input clarification element; and transmitting the structured search query. When no portion of the text input matches a recognized pattern, the method includes: receiving the execution command at the search bar; generating an unstructured search query based on the text input; and transmitting the unstructured search query.

### TECHNICAL FIELD

The disclosure relates to a graphical user interface for generating structured search queries using input clarification elements.

### BACKGROUND

Many applications offer search capabilities. For example, a search application receives user-provided search queries and, in response to the search queries, returns search results. One aim of a search application is to provide relevant search results. A search result can be considered relevant if the linked to content (also referred to as the linked to application state) is responsive to the search query. For example, if a user enters the search query “flights to JFK,” a search result linking to a travel application may be considered a relevant search result, while a search result linking to state of an encyclopedia application discussing former U.S. President John F. Kennedy may not be relevant. Today's search application users tend to provide shorter search queries (i.e., less query terms per search query). In such circumstances, a search application may not be able to discern the intent behind the search query, especially if one or more of the query terms may be ambiguous.

### SUMMARY

According to some implementations of the present disclosure, a method that is executed by a processing device is presented. The method includes displaying a graphical user interface including a search bar. The search bar receives text input via a user interface of the user device. The method includes receiving initial text input at the search bar and determining whether at least a portion of the initial text input matches a recognized pattern. When at least a portion of the text input matches one or more recognized patterns, the method includes: presenting one or more input clarification elements corresponding to the one or more matching recognized patterns; receiving a selection of one of the input clarification elements; receiving an execution command at the search bar; generating a structured search query based on the selected input clarification element; and transmitting the structured search query to a remote device via a network. When no portion of the text input matches a recognized pattern, the method includes: receiving the execution command at the search bar; generating an unstructured search query based on the text input; and transmitting the unstructured search query to the remote device.

According to some implementations of the present disclosure a user device is presented. The user device includes: a user interface; a storage device; a network interface; and a processing device that executes one or more computer readable instructions. The computer readable instructions, when executed by the processing device, cause the processing device to display a graphical user interface including a search bar via the user interface. The search bar receives text input via the user interface. The instructions further cause the processing device to receive, via the user interface, initial text input at the search bar and determine whether at least a portion of the initial text input matches a recognized pattern. When at least a portion of the text input matches one or more recognized patterns, the instructions cause the processing device to present one or more input clarification elements corresponding to the one or more matching recognized patterns; receive, via the user interface, a selection of at least one of the input clarification elements; receive, via the user interface, a search execution command at the search bar; generate a structured search query based on the selected input clarification element; and transmit the structured search query to a remote device via a network. When no portion of the text input matches a recognized pattern, the instructions cause the processing device to receive the search execution command at the search bar; generate an unstructured search query based on the text input; and transmit the unstructured search query to the remote device.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematics respectively illustrating an example environment of a user device configured to present input clarification elements.

FIG. 2A is a schematic illustrating a user device executing a search GUI configured to present input clarification elements and example components thereof.

FIG. 2B is a schematic illustrating the search GUI interaction with example components of the user device.

FIGS. 2C-2L are schematics illustrating an example user device presenting various example user input elements.

FIG. 3 is a flow chart illustrating an example set of operations of a method for executing a search on a user device using input clarification elements.

Like reference symbols in the various drawings indicate like elements.

### DETAILED DESCRIPTION

Any application offering a search function aims to provide relevant search results in a timely manner. As users have grown to expect almost instantaneous search results, the amount of time afforded to a search system to process and understand a search query is on the order of milliseconds. Compounding this issue is that users of mobile devices (which account for a large percentage of all search queries) tend to submit shorter search queries (e.g., fewer terms). Shorter search queries may result in less context for the search system to discern the intent of the search query. For example, a search query only containing the term “jfk” does not offer much context. The user may be referring to president John F. Kennedy or John F. Kennedy International Airport.

Typically, an application that offers search functions presents a graphical user interface (GUI) that includes a search bar (or an analogous user interface element). A search bar is a graphical user interface element that allows a user to enter search terms in the form of text. A search query includes one or more query terms. Upon receiving an instruction to execute the search query, the application can capture one or more query parameters and can transmit the search query and the query parameters to a remote device (e.g., a server associated with the application).

The present disclosure relates to a graphical user interface that allows users to clarify the search query at query time. As the user enters a search query into the search bar, the graphical user interface can present the user with input clarification elements to insert into the search bar. An input clarification element is a graphical user interface element that the user can select to confirm the meaning of one or more query terms. Input clarification elements can include entity units and/or specialized input elements.

An entity unit is a graphical element that displays a text or another value indicating an entity. An entity unit may have one or more entity types associated therewith. For example, in response to a user entering the query term “giants,” a first entity unit corresponding to the query term may recite the term “New York Giants” and may have an entity type of “NFL team” (or the like) associated therewith. A second entity unit may recite the term “San Francisco Giants” and may have the entity type “MLB team” associated therewith. In this way, a user can select one of the entity units (e.g., by dragging the entity unit into the search bar) for inclusion into the query. By doing so, the user has indicated the meaning of the term “giants.” In some implementations, the graphical user interface may further display related entity units. A related entity unit is an entity unit that defines an entity that could replace an entered term. For instance, if the user enters the query term “hamburgers,” the graphical user interface may present one or more of the following related entity units: “tacos,” “pizza,” or “hot dogs.” In this way, the user can easily replace one query term (or terms) with a similar query term (or terms), in addition to clarifying the meaning of the term(s). In some implementations, the entity unit does not have any entity types associated therewith. The entity units may however be manipulated in the search bar (e.g., combined, rearranged, substituted with other entity units) to allow for easier manipulation of the search query.

A specialized input element is a graphical user interface element that allows the user to enter specific types of values. For example, a specialized input element may be a calendar input element that allows a user to easily enter a date. In another example, a specialized input element may be a menu that allows a user to select from a list of options. In response to a user selecting a specialized input element, the user can use the specialized input element to further define the query terms.

In some implementations, once a user executes a search query (e.g., presses on a search button), an application can generate a structured search query based on the entered text and one or more selected input clarification units. A structured search query is a search query where at least a portion of the search query is tagged with additional information. In some implementations, one or more terms corresponding to a selected entity unit may be tagged with one or more entity types. Similarly, the application can translate the input provided to a selected specialized input element into one or more query terms and may tag the input with an entity type. In the scenario where the user is not presented with input clarification units and/or does not select any input clarification units, the application can transmit an unstructured search query. An unstructured search query is the raw text entered by the user in the search box.

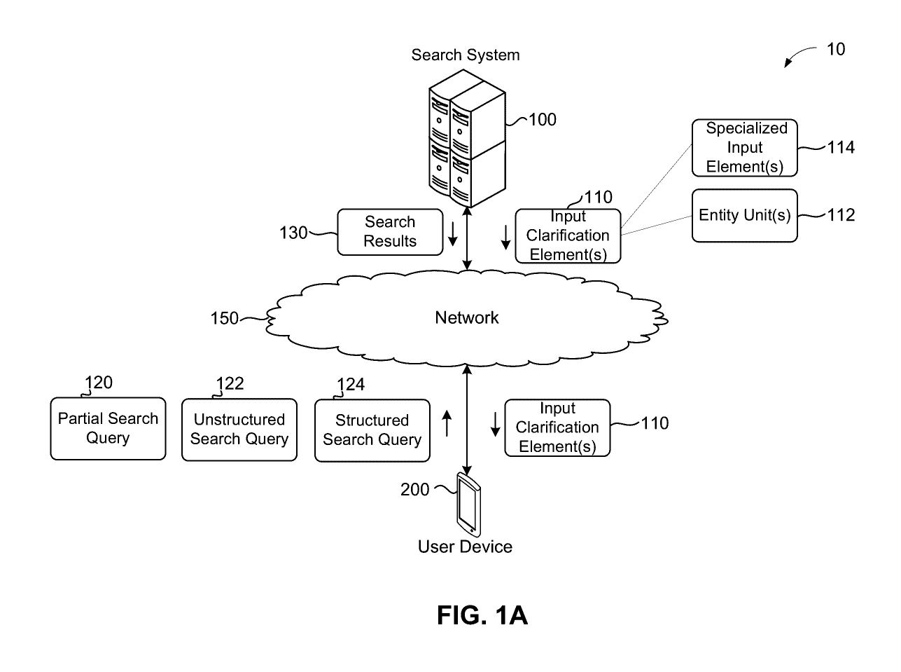

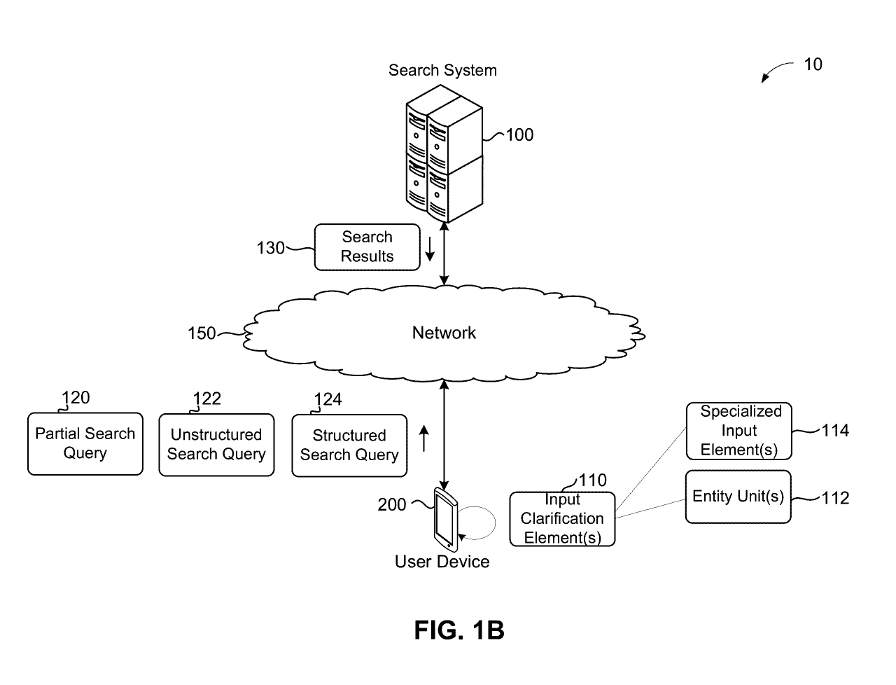

FIGS. 1A and 1B illustrate an example environment 10 of a user device 200 configured to present input clarification elements 110 to a user and a search system 100 that is configured to receive search queries 120, 122, 124 from a user device 200 (one of many user devices 200 that communicate with the search system 100). The search system 100 may be a general search system (e.g., a search engine) or may support one of an application's multiple functions (e.g., a restaurant search offered by a restaurant review/finder application). The search engine 100 generates and transmits a set of search results 130 to the user device 200.

In FIG. 1A, the user device 200 transmits partial search queries 120 to the search system 100. A partial search query 120 is a string of one or more characters entered by the user via a user interface (e.g., touch display screen) of the user device 200 prior to the user executing the search. A user can execute a search by, for example, issuing a search execution command (e.g., pressing on or clicking on a search button displayed in or next to a search bar). Prior to executing the search, the user device 200 transmits partial search queries 120 to the search system 100. For example, a user may be searching for tickets to an upcoming San Francisco Giants game. In this example, the user may intend on entering the search query “giants tickets.” As the user enters the query, the user device 200 may transmit one or more partial search queries 120. In this example, one such partial search query 120 may be “giants.” It is noted that the application (web or native) executing on the user device 200 may be configured to send partial queries at each key stroke or when the user enters a delimiter character (e.g., a space character, a comma, or a period).

In response to a partial search query, the search system 100 may respond with one or more input clarification elements 110. The search system 100 may provide an input clarification element 110 if at least a portion of the partial search query 120 matches a recognized pattern. In some implementations, when the search system 100 determines that at least a portion of the partial search query 120 matches at least a portion of an entity, the search system 100 transmits one or more entity units 112 corresponding to the matched entity. For instance, if the user has entered the partial search query 120 “giants,” the search system 100 may transmit a first entity unit representing “San Francisco Giants,” a second entity unit representing “New York Giants,” and a third entity unit representing “They Might Be Giants” (a musical group). Furthermore, in some implementations, the search system 100 may be configured to transmit alternate entity units 112. For instance, if the user enters the partial query “new york giants,” the search system 100 may return entity units 112 representing the entities “New York Giants,” “New York Jets,” “New York Yankees,” and other seemingly related entities.

In some implementations, when the search system 100 determines at least a portion of the partial search query 120 matches a pattern associated with a commonly entered parameter, the user device 200 may present a specialized input element 114. For example, if the user appears to be entering a date, a time, a telephone number, an amount, or an address, the search system 100 may return a specialized input element 114 configured to receive the parameter type. In a specific example, if the user begins to enter the query “dec 12 tv,” the search system 100 may recognize that the user is entering a date and may provide a calendar input element 114. The user can select the calendar input element 114 to enter a complete date (e.g., Dec. 12, 2015). According to some implementations, the user can enter and/or alter a date in a calendar input element 112. Upon executing the search query, the user device 200 may transmit a structured search query 122 indicating the entered date in a structure understood by the search system 100 along with any other entered text. The search system 100 can narrow the search results 130 to include search results 130 that are relevant to the entered date. Additionally, the user can alter dates in subsequent search queries using the calendar input element 114. In this way, the user can easily run multiple similar search queries 124 only having to use the specialized input element 114.

Upon receiving the input clarification element(s) 110, the user device (e.g., the application executing on the user device and displaying the search bar) can display the input clarification element(s) 110 in relation to the search bar (e.g., below the search bar or in the search bar). The user can then select one or more input clarification elements to include in the search query. For instance, the user can press on an input clarification element 110 and swipe the input clarification element 110 into the search bar. The user can enter additional text into the search bar and/or enter parameter values into a specialized input element 114. Upon executing a search query with one or more input clarification elements, the user device 200 generates a structured search query 124 and transmits the structured search query 124 to the search system 100. In the event the user does not use an input clarification elements 110, the user device 200 generates an unstructured search query 122 and provides the unstructured search query 122 to the search system 100. The search system 100 returns search results 130 in response to the search query 122 or 124. The user device 200 can display the search results 130 via its user interface.

The search system 100 can determine the input clarification elements in any suitable manner. For instance, the search system 100 can index all known input clarification elements 110 by a keyword index. In these implementations, the search system 100 receives a partial search query 120 and can query the index (e.g., an inverted index) with the terms found in the partial search query 120 and/or combination of terms found in the partial search query 120. In some implementations, the search system 100 may identify alternate input clarification elements based on the identified input clarification elements 110. For instance, the search system 100 may include a knowledge base that identifies entities in an entity graph. Using the entity graph, the search system 100 may identify other relevant input clarification elements based on having the same entity types. The search system 100 may also employ any other suitable means to determine the input clarification elements 120 in response to a partial search query 120.

In FIG. 1B, the user device 200 is configured to determine input clarification elements without sending partial search queries 120 to the search system 100. In the implementations of FIG. 1B, the user device 200 analyzes the text inputted into the search bar to determine if at least a portion of the text matches a recognized pattern. In the event the user device 200 matches a portion of the text to a recognized patter, the user device 200 can retrieve an input clarification element 120 from a storage device and can display the input clarification element 120 in proximity to the search bar. The user may select one or more input clarification elements 120 and/or may enter additional text into the search bar. Upon receiving an instruction to execute the search, the user device 200 can generate a structured search query 124 in the manner described above. In the event the user did not select any of the input clarification elements 110, the user device 200 may transmit an unstructured search query 122.

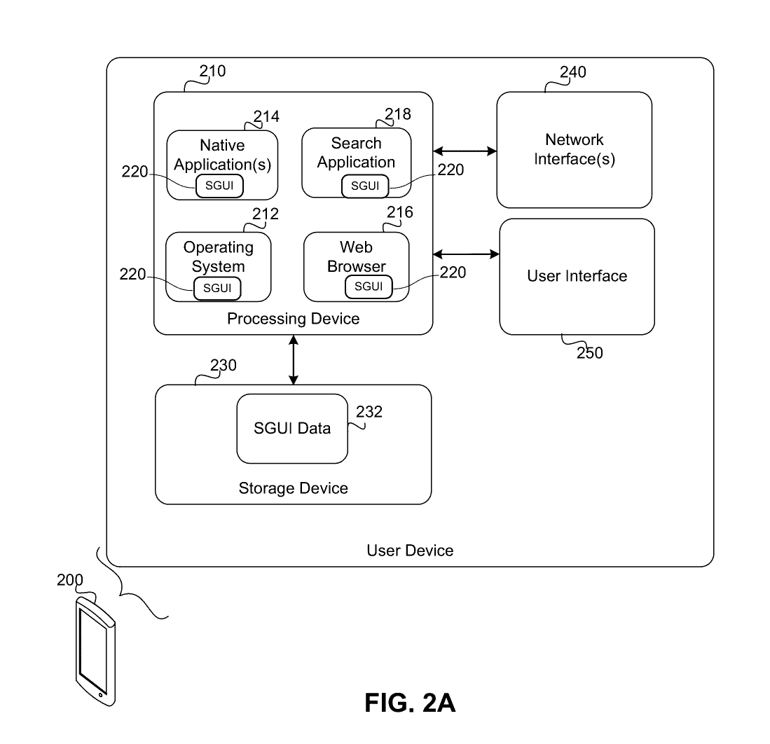

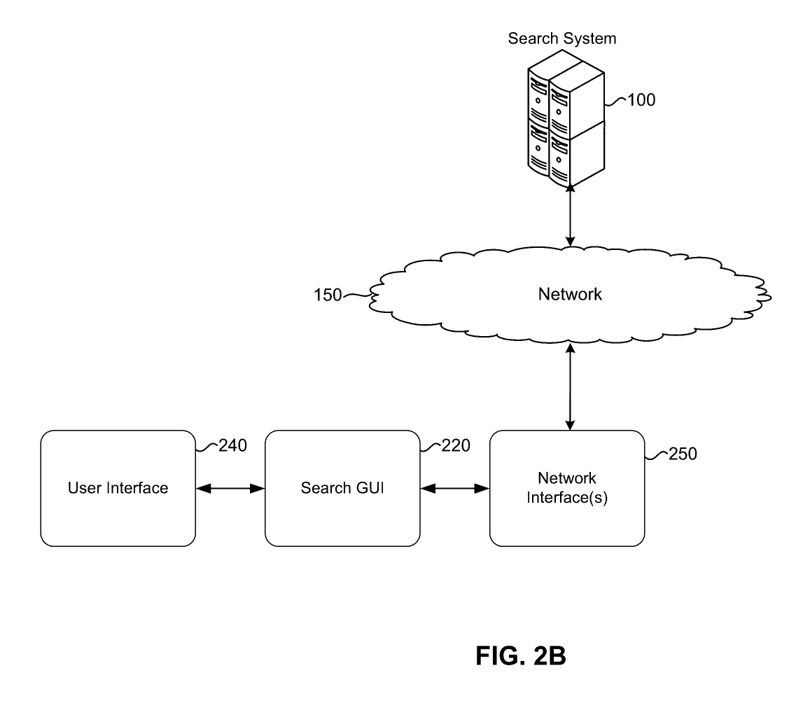

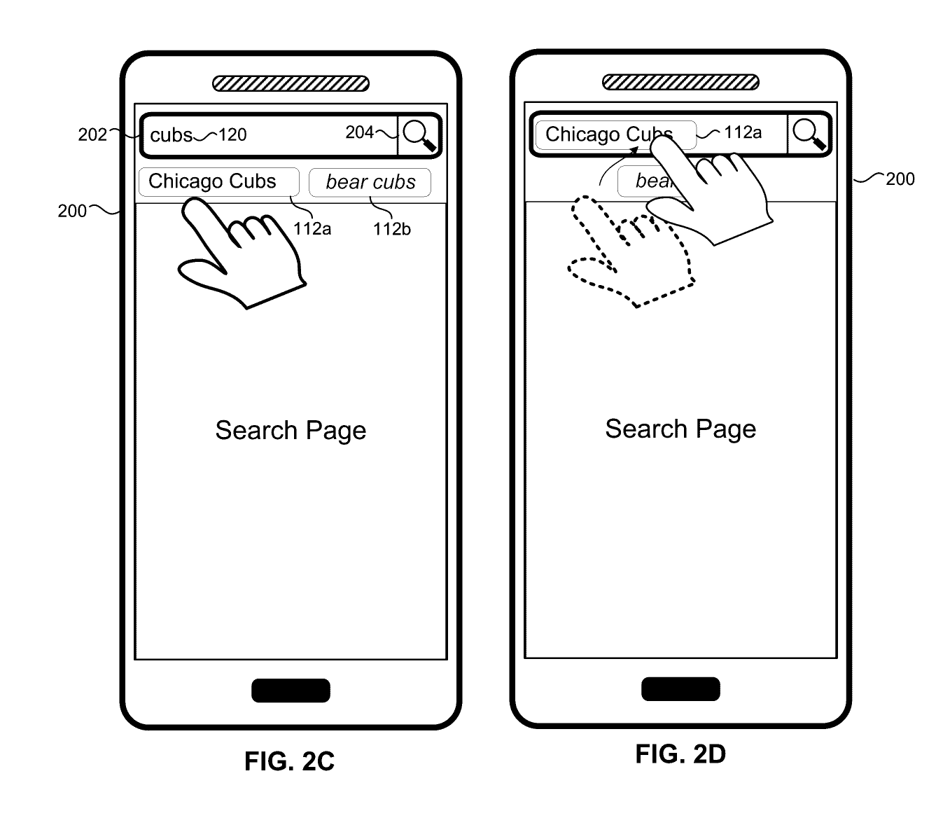

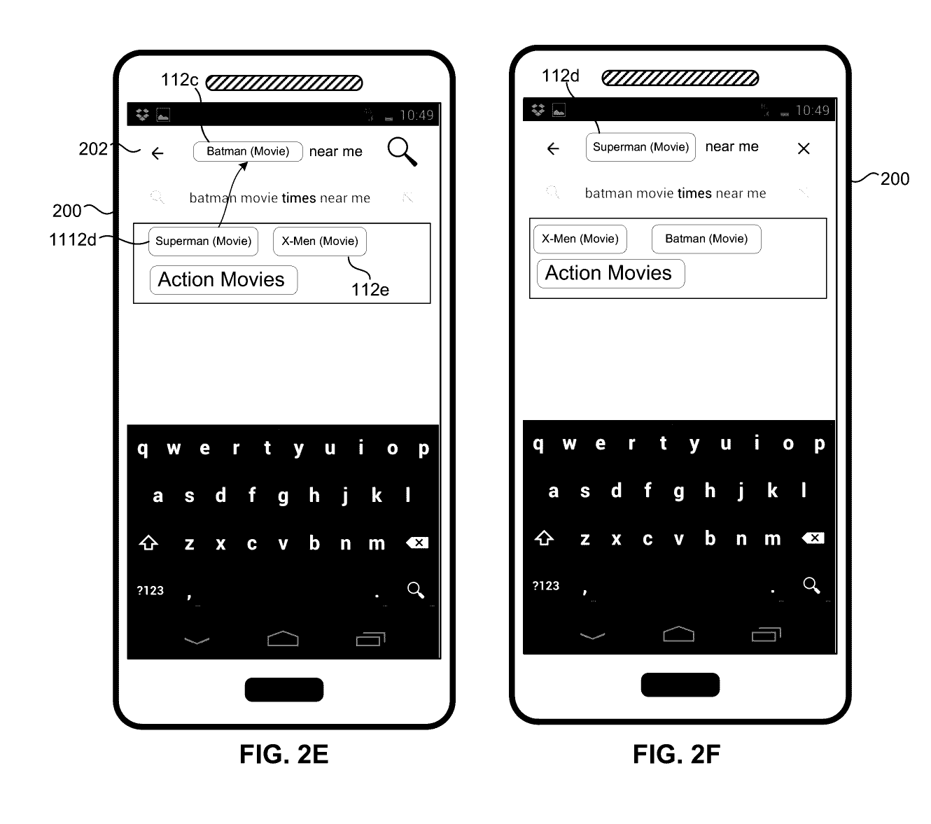

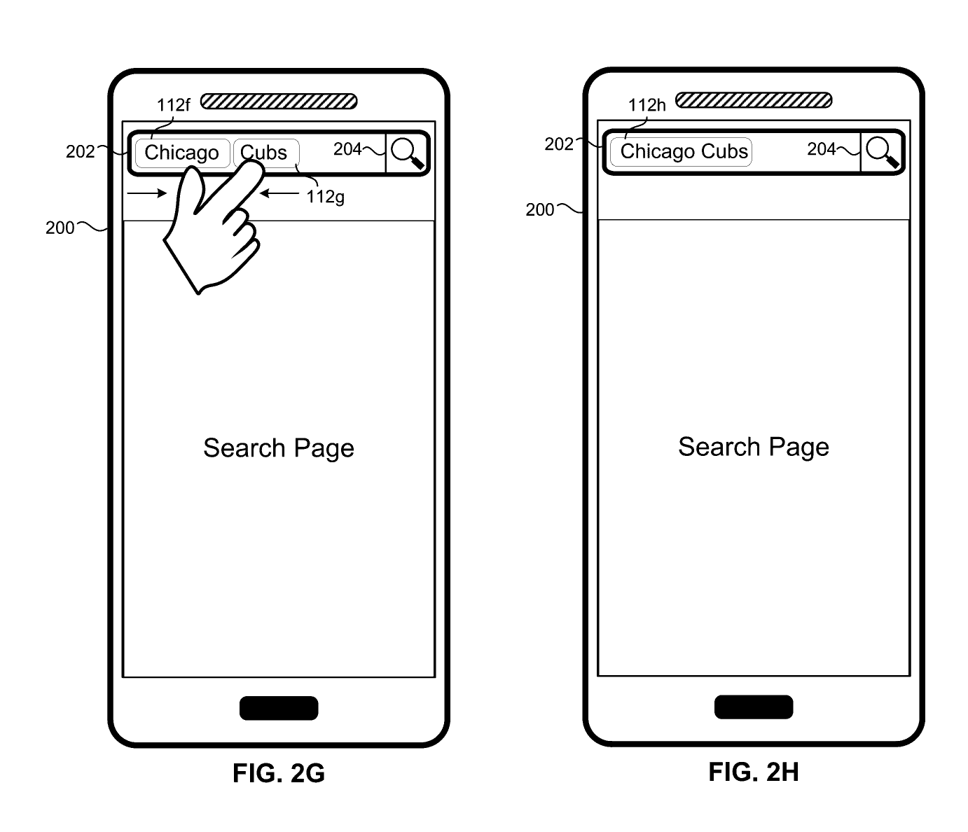

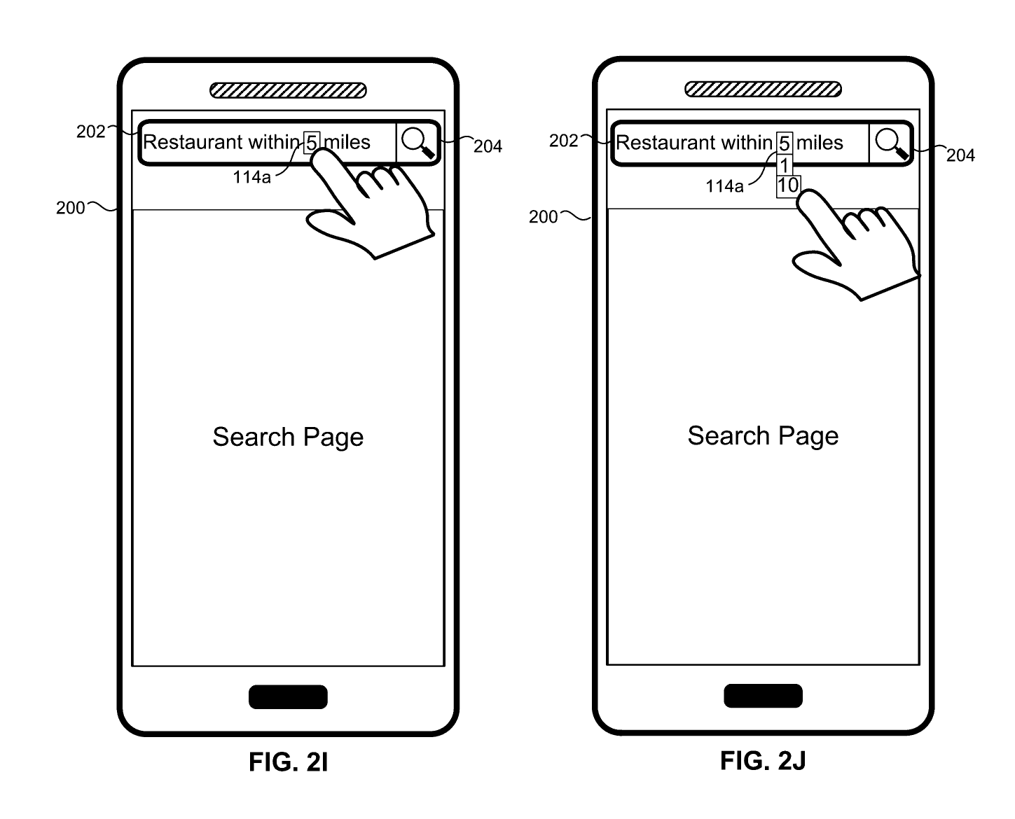

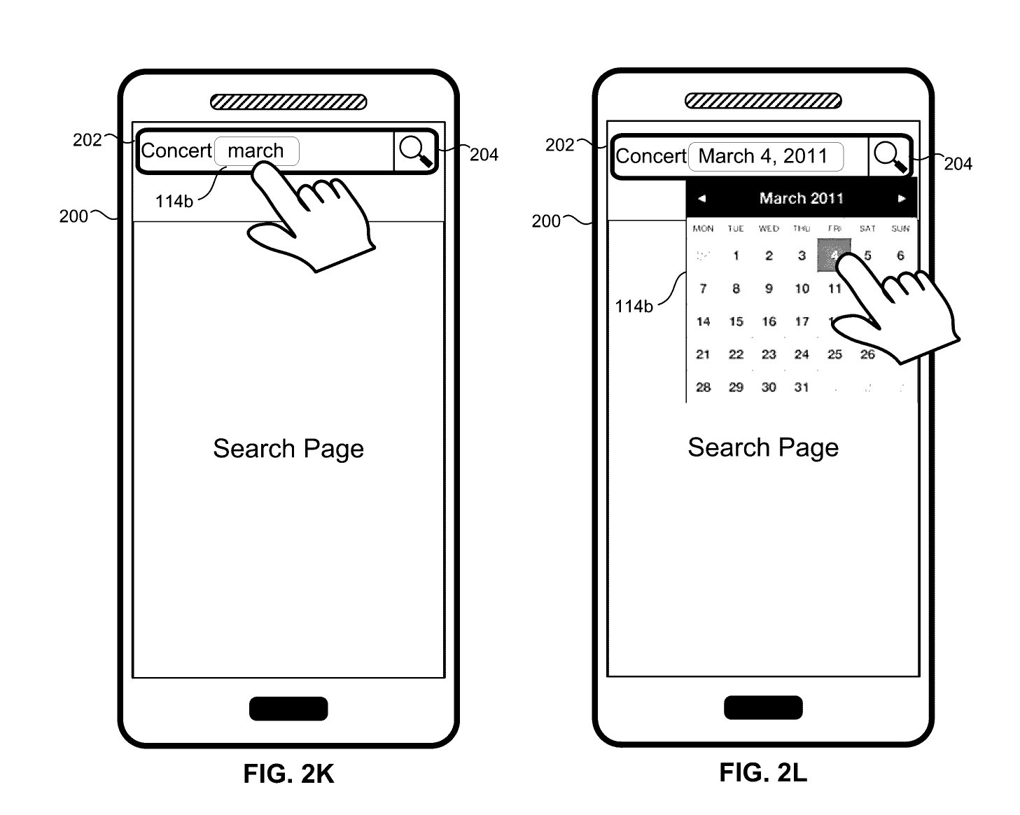

FIG. 2A illustrates an example of a user device 200 configured to display input clarification elements and example components thereof. In the illustrated example, the user device 200 includes a processing device 210, a storage device 230, a network interface 240, and a user interface 240. The user device 200 may include other components not explicitly shown.

The processing device 210 includes one or more physical processors that execute computer-readable instructions (e.g., executable computer code) and memory (e.g., RAM and/or ROM) that stores the computer-readable instructions. In implementations where the processing device 210 includes two or more processors, the two or more processors can operate in an individual or distributed manner. The processing device 210 may execute an operating system 212 and one or more native applications 214. The one or more native applications may include a web browser 216 that executes web applications and/or a native search application 218 that performs searches. The operating system 212, the web browser 216, the native search application 218, and any other native applications 214 may offer some sort of searching functionality. Thus, the operating system 212, the web browser 216, the native search application 218, and any other native applications 214 may include a search GUI 220. The search GUI 220 is a set of computer-readable instructions that are executed by the processing device 210. The configuration of the search GUI 220 is described in further detail below.

The network interface 240 includes one or more devices that are configured to communicate with the network 150. The network interface 240 can include one or more transceivers for performing wired or wireless communication. Examples of the network interface 240 can include, but are not limited to, a transceiver configured to perform communications using the IEEE 802.11 wireless standard, an Ethernet port, a wireless transmitter, and a universal serial bus (USB) port. The user interface 250 includes one or more devices that receive input from and/or provide output to a user. The user interface 250 can include, but is not limited to, a touchscreen, a display, a QWERTY keyboard, a numeric keypad, a touchpad, a microphone, and/or speakers.

The storage device 230 can include one or more computer readable storage media (e.g., hard disk drives and/or flash memory drives). The storage device 230 can store the installed applications 218. In some implementations, the storage device 230 stores search GUI data 232. Search GUI data 232 may include any data that is used to display a search bar, search results, and/or other data used to display or receive data relating to the search functionality.

Further, in implementations where the user device 200 is tasked with determining whether to present input clarification elements 110 to the user, the search GUI data 232 may include input clarification elements 110. For example, the search GUI data 232 may include specialized input elements 114, such a calendar input element, a time input element, a telephone input element, or the like. Additionally, the search GUI data 232 may include grammars or rules to recognize patterns in the partial search query 120. For example, the grammar that recognizes date entries may include abbreviations for dates and/or formats of dates. In some implementations, some or all of the search GUI data 232 may be provided from the search system 100.

A search GUI 220 is the graphical user interface of a native application that allows the user to enter search queries 120 into a search bar. The search GUI 220 can be embodied by a set of computer readable instructions that are executed by the processing device 210. The search GUI 220 includes logic for handling user input and for interfacing with the search system 100. As shown in FIG. 2B, the search GUI 220 may interface with the search system 100 via a network 150. The search GUI 220 may transmit partial search queries 120, structured search queries 124, and unstructured search queries 122 to the search system 100 via the network 150. The search GUI 220 may receive input clarification elements 110 and/or search results 130 from the search system 100 via the network 150. Furthermore, the search GUI 220 interfaces with the user via the user interface 240.

In operation, the search GUI 220 presents a GUI including a search bar 202 (or an analogous text input element). FIGS. 2C-2L illustrate examples of a GUI that may be presented by the search GUI 220. The search GUI 220 receives user input via the search bar 202. Typically, the user can select the search bar 202 by pressing on or clicking on the search bar 202. Upon selecting the search bar 202, the user may begin entering a search query via the user interface 240. As the user enters text, the search GUI 220 may intermittently determine whether to present one or more input clarification elements 110 to the user. In some implementations, the search GUI 220 intermittently transmits a partial search query 120 to the search system 100. The search GUI 220 may transmit the partial search query 120 at each key stroke or each time the user enters a term delimiter. Examples of a term delimiter include a space, a period, or a comma.

In the event the search system 100 matches at least a portion of the partial search query 120 to a known pattern (e.g., a word, set of words, and/or a grammar), the search system 100 returns one or more input clarification elements 110 corresponding to the matching portion of the partial search query 120. The search GUI 220 can present the received input clarification elements 110 in relation to the search bar 202. If the user does not select any of the input clarification elements 110 and executes the search, the search GUI 220 may transmit an unstructured search query 122 to the search system 100. If the user selects one or more of the input clarification elements 110, and optionally, enters more text or input, the search GUI 220 may transmit a structured search query 124 to the search system 100. The structured search query 124 may be configured in a manner that is understood by the search system 100. In some implementations, a structured search query 124 may be a Boolean query that includes tags for at least a portion of the search query. For example, the Boolean query may utilize brackets to delineate a tag (e.g., [tag_id]). Specific examples of structured search queries are provided in the examples of FIGS. 2C-2L. In response to an unstructured or a structured search query 122, 124 the search system 100 returns search results. The search GUI may present the search results via the GUI.

FIGS. 2C and 2D illustrate an example of the search GUI presenting entity units 112. In FIG. 2C, the user has entered the text “cubs” into the search bar 202. The search GUI 220 provides a partial search query 120 indicating “cubs” to the search system 100. The search system 100 returns two entity units 112 to the search GUI 220. The first entity unit 112a indicates the entity “Chicago Cubs.” The first entity unit 112a may further include an entity tag corresponding to the entity “Chicago Cubs.” For example, the entity unit 112a may include one or more of the following tags [MLB team], [Sports team], or [team name]. The second entity unit 112b indicates the entity “bear cubs.” The second entity unit 112b may further include an entity tag corresponding to the entity “bear cubs.” For example, the entity unit 112a may include the tag [animal]. As shown in FIG. 2C, the user is selecting the first entity unit 112a. The user can press and swipe the first entity unit 112 into the search bar 202. As shown in FIG. 2D, the user has swiped the first entity unit (“Chicago Cubs”) into the search bar. As shown in FIG. 2D, the selected entity unit 112a is a singular unit that can be swiped in and out of the search bar 202. In this way, the user can easily manipulate the partial search query 120 before execution of the search. Once the user executes the search, the search GUI 220 can generate a structured search query 124. For example, in this example the structured search query 124 may be (“Chicago Cubs” [MLB Team]). If the user had further entered the text “tickets” after the search query shown in FIG. 2D, the structured search query may be (“Chicago Cubs” [MLB Team] & tickets).

In some implementations, the search system 100 provides related entity units 112 to the search GUI 220. A related entity may be an entity unit 112 that defines an alternate entity unit 112 or a term that can be used to further narrow the search query. In these implementations, the search GUI 220 provides a partial search query 120 to the search system 100. The partial search query 120 may include selected entity units 112. In response to a detected entity unit 112 in the partial search query 120, the search system 100 may identify related entity units 112 to provide to the user device 200. In response to receiving the related entity units 112, the search GUI 220 may present the related entity units in relation to the search bar 202.

FIG. 2E illustrates an example of a user device 200 displaying related entity units 112. In the example of FIG. 2E, the user has entered the partial search query 120 “Batman near me” and has selected the entity unit 112c for “Batman (movie).” In response to the user selection, the search system 100 returns a set of related entity units, including a related entity units 122d, 122e for “Superman (movie)” and “X-men (movie).” In FIG. 2F, the user has swiped the “Superman (movie)” entity unit 112d to replace the “Batman (movie) entity unit 112c. In this way, the user can now search for Superman movies instead of Batman movies without having to delete or type additional text. Upon receiving an instruction from the user to execute the search, the search GUI 220 can generate a structured search query 124 using the related entity unit 124d. For instance, the structured search query 124 may be ((“Superman (movie)” [movies]) & near me)). The search GUI 220 can transmit the structured search query 124 to the search system 100. It is noted that the related entity units 112 may be presented when the user selects an entity unit 112 and/or after the user executes a search. Put another way, the search GUI 220 may allow the user to edit the search query prior to or after executing a search.

In some implementations, the search GUI 220 allows users to manipulate the entity units 112. FIGS. 2G and 2H illustrate an example of a search GUI 220 that allows users to manipulate entity units 112 appearing in a partial search query. In FIG. 2G, the search GUI 220 is displaying two entity units 112f and 112g in the search bar 202. In FIG. 2G, the user pinches the two entity units 112f, 112g. The foregoing is an example of an instruction to combine the two entity units 112f, 112g. In response to the instruction, the search GUI 220 generates a new entity unit 112h (FIG. 2H). In some implementations, the search GUI 220 may apply an “undefined” or “null” tag to the new entity unit. In this way, the search terms corresponding to the new entity unit are treated as a singular entity, but of unknown type. In FIG. 2H, the search GUI 220 has combined the two entity units 112f, 112g into a singular entity unit 112h. In response to the user instructing the search GUI 220 to execute the search (e.g., by pressing the search button 204), the search GUI 220 may generate a structured search query 124 and may transmit the structured search query 124 to the user device 200. For example, the search GUI 220 may generate the following structured search query 124: (“Chicago Cubs” [undefined]).

FIGS. 2I-2L illustrate examples of the search GUI 220 utilizing specialized input elements 114. As previously discussed, a specialized input element 114 is an input clarification element 110 that allows a user to enter values of specific parameters. For example, a specialized input element 114 may be a calendar input element that receives dates, a numerical input element that receives discrete values, or a phone number input element that receives phone numbers.

FIG. 2I and FIG. 2J illustrate an example of a search GUI 220 displaying a specialized input element 114a that receives discrete numerical values. In FIG. 2I, the user has entered the partial query “Restaurant within 5 miles.” In this example, the search GUI 220 has determined that the user is attempting to enter a numerical value and has displayed a specialized input element 114 that receives discrete numerical values. In some implementations, the search GUI 220 may determine that the user is attempting to enter a numerical value by transmitting the partial search query 120 to the search system 100. In these implementations, the search system 100 returns the specialized input element 114. In response to receiving the specialized input element 114, the search GUI 220 may display the specialized input element 114 in relation to the search bar 202. In the example of FIG. 2I, the specialized input element 114 is displayed in the search bar 202. The user can change the value displayed in the specialized input element 114. For example, the user may select (e.g., press) the specialized input element 114. In FIG. 2J, the search GUI 220 has received a selection of the specialized input element. In response to the user selection of the specialized input element 114, the search GUI 220 displays a drop-down menu. The user can select an item from the drop-down menu (e.g., “10”). In response to the user executing the search, the search GUI 220 may generate a structured search query 124. For example, the search GUI 220 may generate the following structured search query 124 (restaurant within & “10 miles”).

FIGS. 2K and 2L illustrate an example of a search GUI 220 displaying a specialized input element 114 that receives dates (referred to as a calendar input element). In FIG. 2K, the user has entered the partial search query 120 “Concert march.” In this example, the search GUI 220 determines that the user may intend to enter a date. In some implementations, the search GUI 220 may make this determination by providing the partial search query 120 to the search system 100 and awaiting a response from the search system 100. In these implementations, the search system 100 may return a calendar input element 114. In other implementations, the search GUI 220 may make this determination by matching at least a portion of the search query to a recognized pattern. In this case, the search GUI 220 may match the term “march” to a pattern associated with dates. In some implementations, the search GUI 220 is configured to recognized patterns that include a month name in full, a month name abbreviations (e.g., “mar” or “jan”), and partial/misspelled month names. Furthermore, the search GUI 220 may be configured to recognize numbers ranging from 1-31 in combination with the years 19XX or 20XX. In this way, the search GUI 220 can recognize when the user has entered a string that resembles a date, and can present the user with the opportunity to utilize a specialized input element if the user's intent was in fact to enter a date. In response to matching the partial search query to a pattern associated with dates, the search GUI 220 can retrieve a calendar input element 114b from the GUI data 232 and may display the calendar input element 114b in relation to the search bar 202.

In response to the user selecting the calendar input element 114b, the search GUI 220 expands the calendar input element 114b. In this way, the user can select a data using a calendar. In the example of FIG. 2L, the user has selected the date Mar. 4, 2011. In response to receiving an instruction to execute the search, the search GUI 220 can generate a structured search query 124 based on the text entered in the search bar 202 and the input entered into the calendar input element 114b. In this example, a structured search query 124 may be: (Concert && date=(03.04.2011)). The search GUI 220 may transmit the structured search query 124 to the search system 100.

In the examples of FIGS. 2C-2L, the user selects the input clarification elements 110. In the case where the user does not select an input clarification element 110, the user may continue to type the search query 120 and/or execute the search. In response to a user instruction to execute the search, the search GUI 220 may transmit an unstructured search query 122 to the search system. An unstructured search query 122 is a search query that is based on the raw text entered into the search bar. Furthermore, the search bar 202 depicted in FIGS. 2C-2L are displayed in a dedicated search application. As mentioned, the search bar 202 may be displayed by the operating system (e.g., at a home screen of the user device), a search application (a native or web search application), and/or a native application offering search capabilities.

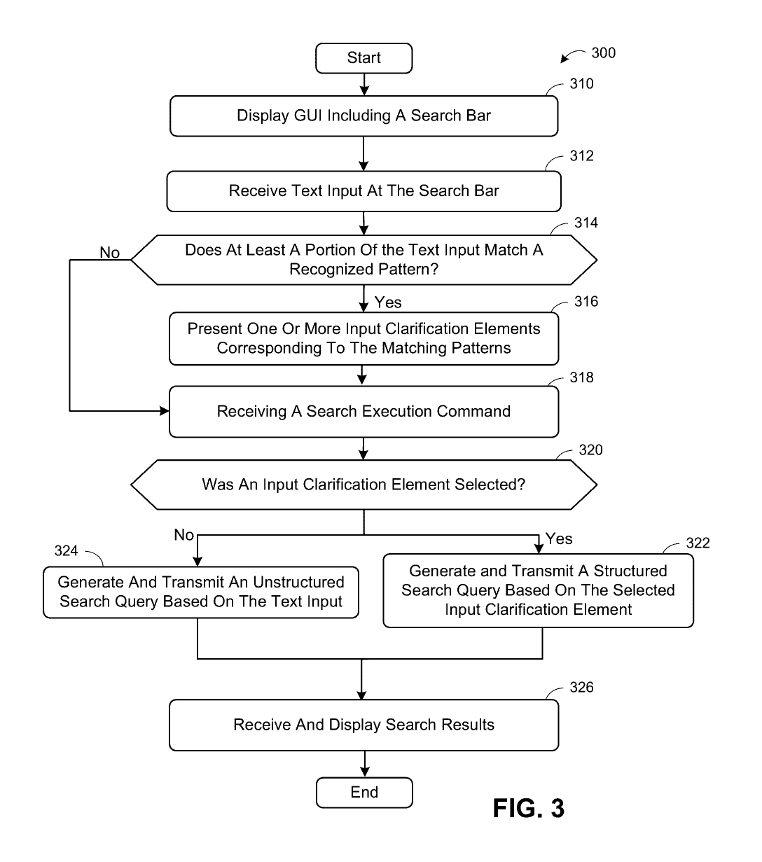

FIG. 3 illustrates an example set of operations of a method 300 for performing a search on a user device 200. The method 300 is described with respect to the user device 200 of FIG. 2A.

At 310, the search GUI 220 displays a search bar 310. As previously discussed, the search bar 202 may be displayed in a number of different settings. For instance, the search bar 202 may be at the top of a web browser GUI, at a location on the home screen of the user device 200, or displayed in the GUI of a search application.

At 312, the search GUI 220 receives text input at the search bar 202. To enter text input, a user may select (e.g., press on) the search bar 202 and may begin entering text using the user interface. For example, in response to receiving user selection of the search bar 202, the search GUI 220 may present a touch screen keyboard. The user may enter text using the touch screen keyboard. The search GUI 220 receives the text entered by the user and may display the text in the search bar 202.

At operation 314, the search GUI 220 determines whether at least a portion of the text input matches a recognized pattern. Matching a recognized pattern may include matching a known term or set of terms or matching a grammar. For instance, matching a known term or set of terms may include matching to a known entity. Matching a grammar may include recognizing that the text includes certain chunks of text and/or specific ordering of text. For instance, if the partial search query 110 includes “mar 4,” the partial search query 110 may match to a date pattern.

In some implementations, the search GUI 220 determines whether a portion of the text matches a recognized pattern by transmitting a partial search query 120 to the search system 100. If the search system 100 returns one or more input clarification elements 110, the search GUI 220 determines that at least a portion of the text matches a recognized pattern. The search GUI 220 may transmit partial search queries 120 when the user enters a new character or when the user enters a specific character (e.g., space, period, or comma).

Alternatively, the search GUI 220 may utilize a grammar set to determine if at least a portion of the text matches a recognized pattern. The search GUI 220 may store the grammar set with the GUI data 232. In the event the text matches a grammar in the grammar set, the search GUI 220 may retrieve an input clarification element 110 corresponding to the matched grammar.

If the search GUI 220 determines that at least a portion of the text matches a recognized pattern, the search GUI 220 displays one or more input clarification elements 110 in relation to the search bar 202, as shown at 316. The input clarification elements 110 may include entity unit 112 and/or specialized input elements 114. The entity units 112 may include an entity unit 112 defining an entity representing the matched text and/or alternate entities. The entity unit 112 may include the visual element that is displayed in the GUI as well as metadata, such as a tag corresponding to the entity unit 112. The search GUI 220 may display entity units 112 in proximity to the search bar 202. For instance, the search GUI 220 may display the entity units 112 below the search bar 202, whereby the user can easily swipe the entity units 112 into the search bar 202. In the case of specialized input elements 114, the search GUI 220 may display the specialized input elements 114 in the search bar 202, whereby the user can select the specialized input element 114 by pressing thereon. The specialized input elements 114 may include the visual elements as well as metadata. The metadata may define a template to generate a portion of the structured search query given the input provided by the user into the specialized input element 114.

The user may select one or more of the input clarification elements 110 and/or may continue to enter text. For example, a user searching for tickets to a Chicago Cubs baseball game, may: i) enter the word “cubs;” ii) select an entity unit for “Chicago Cubs;” and iii) enter the text “tickets.” In this way, the user has selected an entity unit 112 and continued to enter text. In the event the search GUI 110 does not determine that at least a portion of the text matches a recognized pattern, the user may still enter additional text. As the user enters more text, eventually the search GUI 110 may determine that a portion of the text matches a recognized pattern and then may display one or more input clarification elements 110 to the user. In some scenarios, the user may be presented with input clarification elements and the user may ignore the input clarification elements 110 altogether.

At 318, the search GUI 220 receives a search execution command via the user interface. The user may initiate a search execution command by selecting (e.g., pressing) on a search button or hitting “enter” on the keyboard.

At 320, the search GUI 220 determines whether any of the input clarification elements 110 were selected, assuming at least one input clarification element 110 was presented via the user interface. If at least one input clarification element 110 was selected, the search GUI 220 generates a structured search query based on the selected input clarification elements 110 and the text entered at the search bar 202, as shown at 322. As previously indicated, the input clarification elements 110 may include a visual element as well as a tag or similar metadata associated with the input clarification element 110. The search GUI 220 includes the text entered by the user that was not replaced by an input clarification element 110 in the structured search query. In the event a selected input clarification element 110 is an entity unit 112, the search GUI 220 includes the text associated with the input clarification element 110 in the structured search query 124 and tags the text with the tag associated with the input clarification element 110. In the event the selected input clarification element 110 is a specialized input element 114, the search GUI 220 can read in the value(s) entered into the specialized input element and may generate a portion of the structured search query 124 using the template provided with the specialized input element 114. The search GUI 220 transmits the structured search query 124 to the search system 100. In some implementations, the search GUI 220 may transmit one or more query parameters with the structured search query 124. For example, the search GUI 220 may include a geolocation and/or a user id with the structured search query 124 to improve the relevance of the search results.

If no input clarification elements 110 were selected, the search GUI 220 generates an unstructured search query 122 based on the text entered at the search bar 202, as shown at 324. The search GUI 220 may read the text from the search bar 202. The unstructured search query 122 may comprise the raw text entered into the search bar 202. The search GUI 220 may transmit the unstructured search query 122 to the search system 100. In some implementations, the search GUI 220 may transmit one or more query parameters with the unstructured search query 122 to improve the relevance of the search results.

At 326, the search GUI 220 receives and displays the search results. The search GUI 220 receives the search results from the search system 100. The search GUI 220 can output the search results via the user interface 240 of the user device 200.

The method of FIG. 3 is provided for example only. The method 300 may include additional or alternate operations.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

1-16. (canceled)

17. A method comprising:
displaying, by a processing device of a user device, a graphical user interface including a search bar, wherein the search bar is configured to receive text input from a user of the user device;
receiving, by the processing device, initial text input at the search bar from the user;
determining, by the processing device, whether at least a portion of the initial text input matches a recognized pattern;
in response to at least a portion of the text input matching one or more recognized patterns:
presenting, by the processing device, a plurality of entity units via the graphical user interface, wherein each entity unit is a graphical user interface element that includes (i) a visible text portion displayed by the entity unit that represents an entity and (ii) an entity tag that is a metadata tag that defines an entity type of the entity represented by the text portion, wherein:
the plurality of entity units include a clarification entity unit and one or more alternative entity units corresponding to the clarification entity unit,
the clarification entity unit indicates a potential construction of the portion of the initial text input that matches the recognized pattern and corresponds to a first entity type, and
each of the alternative entity units respectively indicates an alternative entity of the first entity type;
in response to receiving a selection of one of the plurality of entity units by the user, substituting, by the processing device, the portion of the initial text input that matches the recognized pattern with the entity unit; and
in response to receiving an execution command corresponding to the search bar:
generating, by the processing device, a structured search query based on the selected entity unit; and
transmitting, by the processing device, the structured search query to a remote device via a network.

18. The method of claim 17, further comprising, in response to receiving the execution command when no portion of the text input matches one or more of the recognized patterns:
generating, by the processing device, an unstructured search query based on the text input; and
transmitting, by the processing device, the unstructured search query to the remote device via the network.

19. The method of claim 17, wherein presenting the plurality of entity units includes displaying each of the plurality of entity units at a location that is proximate to the search bar.

20. The method of claim 19, wherein each of the plurality of entity units is configured to be selected via a swipe gesture.

21. The method of claim 20, wherein receiving the user selection of one of the entity units includes receiving user input indicating a swipe gesture from the one of the entity units to the search bar.

22. The method of claim 17, wherein the structured search query is a Boolean search query that includes, for the selected entity unit, the entity tag and the text defining the entity.

23. The method of claim 17, wherein:
determining whether at least a portion of the text input matches a recognized pattern includes determining whether the portion of the text input matches one or more potential entity values; and
presenting the plurality of entity units includes receiving the plurality of entity units from the remote device.

24. A user device comprising:
a computer-readable storage medium configured to store instructions;
a network interface;
a user input/output device; and
a processing device configured to execute the instructions, wherein the instructions include:
displaying a graphical user interface including a search bar on the user input/output device, wherein the search bar is configured to receive text input from a user of the user device;
receiving initial text input at the search bar from the user;
determining whether at least a portion of the initial text input matches a recognized pattern;
in response to at least a portion of the text input matching one or more recognized patterns:
presenting a plurality of entity units via the graphical user interface, wherein each entity unit is a graphical user interface element that includes (i) a visible text portion displayed by the entity unit that represents an entity and (ii) an entity tag that is a metadata tag that defines an entity type of the entity represented by the text portion, wherein:
the plurality of entity units include a clarification entity unit and one or more alternative entity units corresponding to the clarification entity unit,
the clarification entity unit indicates a potential construction of the portion of the initial text input that matches the recognized pattern and corresponds to a first entity type, and
each of the alternative entity units respectively indicates an alternative entity of the first entity type;
in response to receiving a selection of one of the plurality of entity units by the user, substituting the portion of the initial text input that matches the recognized pattern with the entity unit; and
in response to receiving an execution command corresponding to the search bar:
generating a structured search query based on the selected entity unit; and
transmitting the structured search query to a remote device via the network interface.

25. The user device of claim 24, wherein the instructions include, in response to receiving the execution command when no portion of the text input matches one or more of the recognized patterns:
generating, by the processing device, an unstructured search query based on the text input; and
transmitting, by the processing device, the unstructured search query to the remote device via the network interface.

26. The user device of claim 24, wherein presenting the plurality of entity units includes displaying each of the plurality of entity units at a location that is proximate to the search bar.

27. The user device of claim 26, wherein each of the plurality of entity units is configured to be selected via a swipe gesture.

28. The user device of claim 27, wherein receiving the user selection of one of the entity units includes receiving user input indicating a swipe gesture from the one of the entity units to the search bar.

29. The user device of claim 24, wherein the structured search query is a Boolean search query that includes, for the selected entity unit, the entity tag and the text defining the entity.

30. The user device of claim 24, wherein:
determining whether at least a portion of the text input matches a recognized pattern includes determining whether the portion of the text input matches one or more potential entity values; and
presenting the plurality of entity units includes receiving the plurality of entity units from the remote device.

31. A non-transitory computer-readable medium comprising a plurality of computer-readable instructions, the instructions, when executed by a processing device of a user device, causing the processing device to:
display a graphical user interface including a search bar on the user device, wherein the search bar is configured to receive text input from a user of the user device;
receive initial text input at the search bar from the user;
determine whether at least a portion of the initial text input matches a recognized pattern;
in response to at least a portion of the text input matching one or more recognized patterns:
present a plurality of entity units via the graphical user interface, wherein each entity unit is a graphical user interface element that includes (i) a visible text portion displayed by the entity unit that represents an entity and (ii) an entity tag that is a metadata tag that defines an entity type of the entity represented by the text portion, wherein:
the plurality of entity units include a clarification entity unit and one or more alternative entity units corresponding to the clarification entity unit,
the clarification entity unit indicates a potential construction of the portion of the initial text input that matches the recognized pattern and corresponds to a first entity type, and
each of the alternative entity units respectively indicates an alternative entity of the first entity type;
in response to receiving a selection of one of the plurality of entity units by the user, substitute the portion of the initial text input that matches the recognized pattern with the entity unit; and
in response to receiving an execution command corresponding to the search bar:
generate, by the processing device, a structured search query based on the selected entity unit; and
transmit, by the processing device, the structured search query to a remote device via a network.

32. The computer-readable medium of claim 31, wherein the instructions further cause the processing device to, in response to receiving the execution command when no portion of the text input matches one or more of the recognized patterns:
generate an unstructured search query based on the text input; and
transmit the unstructured search query to the remote device via the network.

33. The computer-readable medium of claim 31, wherein presenting the plurality of entity units includes displaying each of the plurality of entity units at a location that is proximate to the search bar.

34. The computer-readable medium of claim 33, wherein each of the plurality of entity units is configured to be selected via a swipe gesture.

35. The computer-readable medium of claim 34, wherein receiving the user selection of one of the entity units includes receiving user input indicating a swipe gesture from the one of the entity units to the search bar.

36. The computer-readable medium of claim 31, wherein the structured search query is a Boolean search query that includes, for the selected entity unit, the entity tag and the text defining the entity.
